(19) United States
(12) Patent Application Publication
(10) Pub. No.: US 2008/0119161 A1
(43) Pub. Date: May 22, 2008

(54) Prepaid wireless service and billing system, apparatus and method

(76) Inventor: Daniel Collart, Pembroke Pines, FL (US)

Correspondence Address: Manuel Valcarcel, Esq;Greenberg Traurig, P.A., 1221 Brickell Avenue, Miami, FL, 33131, US

(21) Appl. No.: 11/601,082

(22) Filed: Nov. 18, 2006

(51) Int. Cl. H04M 11/00

(52) U.S. Cl. 455/408

(57) ABSTRACT

An embodiment of the present invention provides an apparatus, comprising a service and billing platform including a program administration interface associated with a prepaid wireless handset adapted to allow for the creation and management of programs, business rules, customer communications, reports, back end processes, trial and upgrade plans and shared membership plans.

### BACKGROUND OF THE INVENTION

Prepaid cellular service is a form of cellular service in which a user must pay in advance for use of the service. Typically, a user purchases a definite amount of airtime wireless network access (airtime) at an initially pre-defined exchange of monetary value versus units of airtime credit from a prepaid cellular service provider. These measures of units of airtimes are commonly valued at units of minutes (also may be referred to as credits). When the user places or receives a call or otherwise uses the service, the service provider decrements the user's pre-purchased air time units or credits. The rate at which pre-purchased air time unit is deducted per unit of time is known as the deduct rate. Once the pre-purchased airtime unit has been exhausted, the user is denied service until the user purchases additional units.

Recently, in addition to voice calls being made, data communications and various services have become increasingly important using wireless handsets. Data communication may include, but is not limited to: data download, Internet web browsing using wireless access protocol; MSM, and providing Internet connectivity via the mobile communication infrastructure for personal computers. Given the variety of uses and fees associated with such varied uses, there is a strong need in the industry for a prepaid wireless service and billing system, apparatus and method.

### SUMMARY OF THE INVENTION

An embodiment of the present invention provides an apparatus, comprising a service and billing platform including a program administration interface associated with a prepaid wireless handset adapted to allow for the creation and management of programs, business rules, customer communications, reports and back end processes, trial and upgrade plans and shared membership plans.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a system diagram of a wireless service and billing system according one embodiment of the present invention; and

FIG. 2 is a diagram depicting the interconnectivity and method of wireless service and billing according one embodiment of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general-purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

An embodiment of the present invention provides a Service and billing Platform that may be a rules based program that encompasses program management, payment processing and customer communications in an integrated and flexible fashion to efficiently handle current and emerging business needs (such as, but not limited to various promotional activities, service and billing rates, application service and billing, Spanish, English etc.) It works in conjunction with a wireless handset to provide customer minutes and service.

In an embodiment of the present invention, the platform may be comprised of a program administration interface that allows for the creation and management of programs, business rules, customer communications, reports and back end processes, trial and upgrade plans and shared membership plans. Recurring or one-time programs/services may be created that deliver minutes/units/dollar amounts directly from the service and billing platform to the handset or send service due date updates based on the program's definition. A program can be configured by selecting price, the amount of minutes (peak/off peak), service days, charge frequency and frequency of minutes delivery. Several parameters may be used to restrict participation in any program and service. Further, the program may provide for shared minutes, wherein a user of a prepaid wireless device may subscribe to a selected quantity of minutes for each participant of the shared minutes plan. In an embodiment of the present invention, the primary subscriber of the shared plan may allocate desired prepaid minutes to each participate in the shared plan as desired. For example, in a family plan, a father could allocate a desired number of prepaid minutes to each family member. Further, in another embodiment of the present invention, a business adaptable version of the shared minutes can be utilized. In this embodiment, a business can allocate a desired number of minutes during a desired period for the employees of the business. This may be accomplished via a prepaid wireless handset by the wireless handset communicating with a prepaid wireless server associated with the program administration interface which accepts the inputs from the user on desired minutes for each participant in a shared minutes plan. The server than sends (via the methods described below) the authorization to each phone with the updated prepaid minutes authorized. In an embodiment of the present invention, the primary business user may update, add or subtract authorized shared minutes for participants in the share prepaid minutes plan.

The business rules may be configured using system actions, serial number/account status, transaction outcomes, program, timing, payment methods, payment history, stop criteria and other related elements. Within these business rules, communication triggers may be included to communicate with the customer via e-mail, SMS, automated voice blast and/or U.S. mail; although the present invention is not limited to these communication means. The communications can also be configured into rules that include alternate types of communication or follow up communications.

The service and billing platform may also be integrated with a website account system where customers can view their transactions and manage their accounts. Users of the wireless device (which also may be referred to herein as Customers) may pay for their services, add minutes, update their handsets and add funds to their balances as well as change their contact and service and billing information. In addition, the system has been integrated with a customer service system to help customers manage their accounts as they can on the website, and to provide additional services such as refunds, grace period extensions, upgrades, etc.

An objective of one embodiment of the service and billing platform of the present invention may be to provide flexibility to launch programs/services that can be directly billed to customers or institutional groups within a short time period. Also, programs can be customized to fit different groups of customers or individual customers.

There are several key applications of the service and billing platform that have never been used before in the prepaid wireless industry. These include, but are not limited to:
Trial Service Plans which may be scaled down, non-recurring versions of recurring plans created to provide customers with a taste of a full-sized plan. For example, a trial size family plan can be configured at a lower price with less service days and minutes than a similar full-sized recurring Family plan. There may also be trial shared minutes plans and all trial plans may be activated to full service plans; and
Sample Service Plans which may be scaled down, non-recurring versions of recurring plans created to provide customers with a taste of a full-sized plan. For example, a sample service extension plan can be configured with a zero dollar price, less service days and minutes than a similar full-sized recurring service extension plan. Also, all sample plans may be activated to full service plans.
Deliverability of Minutes and Service Updates to Handset which may provide minutes or service date updates delivered directly from service and billing platform systems to the wireless handset after customer's account is charged or delivery criteria is met.
Family or group (i.e. business, affinity, etc.) plans that allow customers to share a customized amount or fixed equal amount of prepaid minutes and/or service days every charge period before delivery of the services to the wireless handset.

Some embodiment of the present invention further provide a method, comprising using a program administration interface with a service and billing platform associated with a prepaid wireless handset to enable the creation and management of programs, business rules, customer communications, reports and back end processes within the service and billing platform. The service and billing platform may be a rules based program that encompasses program management, payment processing and customer communications in an integrated and flexible fashion and may further comprise using the service and billing platform in conjunction with the wireless handset to provide customer minutes and service. The present method may further comprise providing, by the service and billing platform, recurring or one-time programs or services that deliver minutes or units or dollar amounts or send service due date updates from the service and billing platform via the administration interface directly to the wireless handset.

An embodiment of the present method may further comprise configuring the program administration interface by selecting price, the amount of minutes, service days, charge frequency and frequency of minutes delivery and still may further comprise configuring the business rules using one or more of the following selected from the group consisting of: system actions; serial number; account status; transaction outcomes; programs; timing; payment methods; payment history; or stop criteria. The method may further comprise including within the business rules, communication triggers to communicate with the user of the wireless handset via e-mail, SMS, automated voice blast and/or standard mail and integrating the service and billing with a website accounting system where users of the wireless handset can view their transactions and manage their accounts including paying for their services, adding minutes, updating their handsets, adding funds to their balances and changing their contact and service and billing information.

Also, an embodiment of the present method may further comprise adapting the service and billing platform to launch programs and services that can be directly billed to a user of the wireless handset or institutional groups within a short time period.

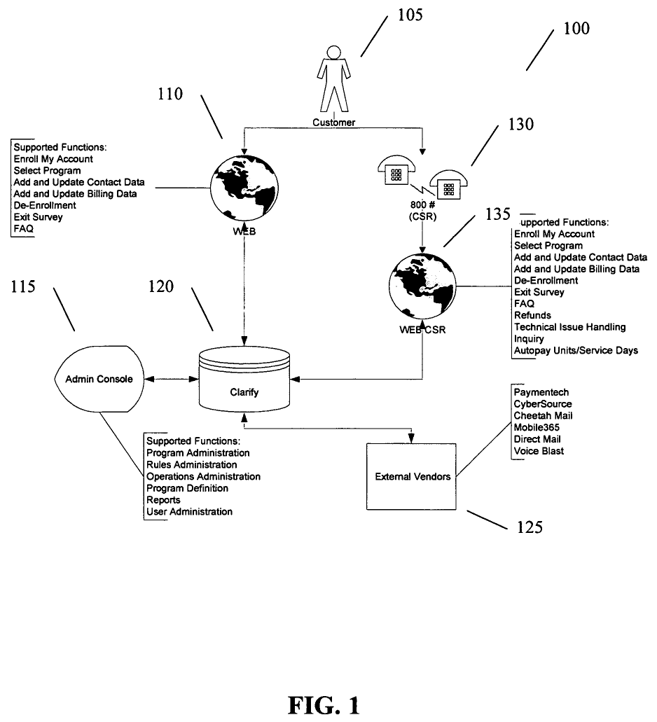

Some embodiments of the invention may be implemented, for example, using a machine-readable medium or article which may store an instruction or a set of instructions that, if executed by a machine, for example, by the system of FIG. 1 or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Still another embodiment of the present invention provides a machine-accessible medium that provides instructions, which when accessed, cause a machine to perform operations comprising using a program administration interface with a service and billing platform associated with a prepaid wireless handset to enable the creation and management of programs, business rules, customer communications, reports and back end processes within the service and billing platform. The service and billing platform may be a rules based program that encompasses program management, payment processing and customer communications in an integrated and flexible fashion and may further comprise the instructions causing the machine to perform operations further comprising using the service and billing platform in conjunction with the wireless handset to provide customer minutes and service and instructions causing the machine to perform operations further comprising providing, by the service and billing platform, recurring or one-time programs or services that deliver minutes or units or dollar amounts or send service due date updates from the service and billing platform via the administration interface directly to the wireless handset.

Some embodiments of the present invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the present invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Yet another embodiment of the present invention provides a system, comprising a prepaid wireless handset, and a service and billing platform including a program administration interface to associate the bill platform with the wireless handset and adapted to allow for the creation and management of programs, business rules, customer communications, reports and back end processes. In an embodiment of the present system, the service and billing platform may be a rules based program that encompasses program management, payment processing and customer communications in an integrated and flexible fashion.

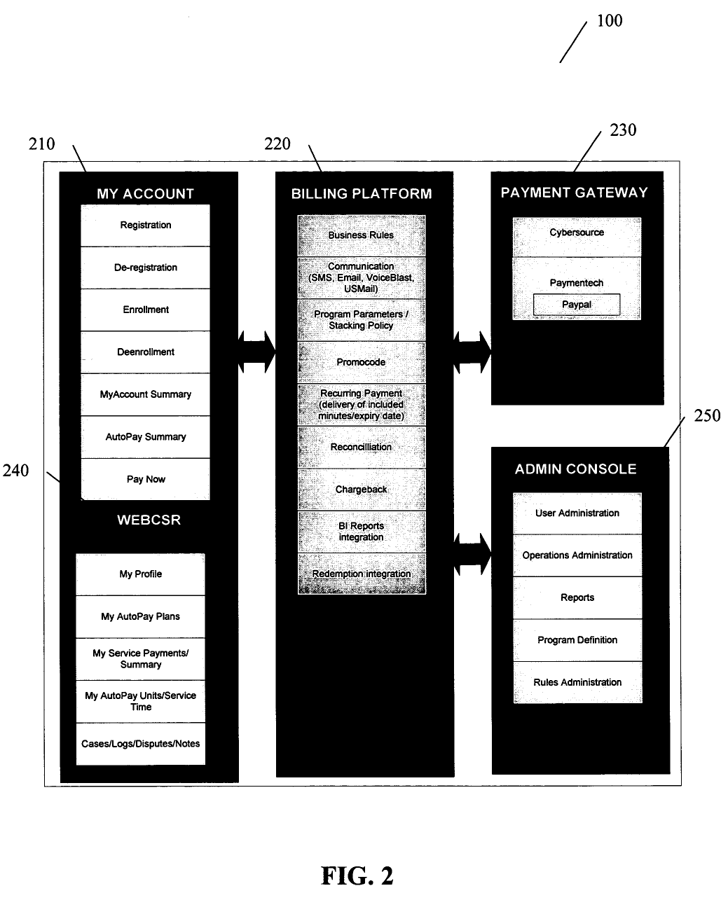

Turning now to the figures, FIGS. 1 and 2 provide high-level diagrams of a service and billing platform according to one embodiment of the present invention. FIG. 1, shown generally as 100, provides a system diagram of a wireless service and billing system according one embodiment of the present invention.

The service and billing platform was designed to work in a modular fashion and to connect several processes into an integrated and synchronized whole. These processes may include a customer via a wireless handset 105 in communication or connected to a customer service representative (CSR) 130 or a website 110 via the Internet. The CSR may access a WEB SCR. The website 110 may include functions such as, but not limited to: Enroll My Account; Select Program; Add and Update Contact Data; Add and Update Service and billing Data; De-Enrollment; Exit Survey; and FAQ. The WEB CSR 135 associated with CSR 130 may support the following functions: Enroll My Account; Select Program; Add and Update Contact Data; Add and Update Service and billing Data; De-Enrollment; Exit Survey; and FAQ; Refunds; Technical Issue Handling; Inquiry; and Autopay Units/Service Days. WEB 110 and WEB CSR 135 may be feed to a customer database clarify server that may be used by customer service agents.

In communication with the customer database clarify server may be an admin console, which supports the following functions: Program Administration; Rules administration; Operations Administration; Program Definition; Reports and User Administration. Also, in communication with the customer database clarify server may be external vendors which support payment vendors such as, but not limited to: Paymentech; CyberSource; Cheetah Mail; Mobile 365; Direct Mail; or Voice Blas.

Turning now to FIG. 2 is a diagram depicting the interconnectivity and method of wireless service and billing according one embodiment of the present invention. Service and billing platform 220 may be associated with a user account 210 and WEBCSR 240 and also payment gateway 230 and admin console 250. As shown at 220, bill platform may include business rules, communication (SMS, Email, Voice Blast, US Mail), program parameters/stacking policy, promo code, recurring payment (delivery of included minutes/expiry date), reconciliation, chargeback, BI reports integration and redemption integration. As shown at 210 My Account data may include registration, de-registration, enrollment, de-enrollment, my account summary, autopay summary and pay now. WEBCSR at 240 may include my profile, my autopay plans, my service payments/summary, my autopay units/Service time and cases/logs/disputes/notes. Payment gateway 230 may include services such as, but not limited to those provided by Cybersource®, Paymentech® or Paypal®. Lastly, admin console 250 may include user administration, operations administration, reports, program definition and rules administration.

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

What is claimed is:

1. An apparatus, comprising:
a service and billing platform including a program administration interface associated with a prepaid wireless handset adapted to allow for the creation and management of programs, business rules, customer communications, reports and back end processes.

2. The apparatus of claim 1, wherein said service and billing platform is a rules based program that encompasses program management, payment processing and customer communications in an integrated and flexible fashion.

3. The apparatus of claim 2, wherein said service and billing platform works in conjunction with said wireless handset to provide customer minutes and service.

4. The apparatus of claim 1, wherein said service and billing platform provides recurring or one-time programs or services that deliver minutes or units or dollar amounts or send service due date updates from said service and billing platform via said administration interface directly to said wireless handset.

5. The apparatus of claim 1, wherein said program administration interface is configured by selecting price, the amount of minutes, service days, charge frequency and frequency of minutes delivery.

6. The apparatus of claim 1, wherein said business rules are configured using one or more of the following section from the group consisting of: system actions; serial number; account status; transaction outcomes; programs; timing; payment methods; payment history; or stop criteria.

7. The apparatus of claim 6, wherein within said business rules, communication triggers are included to communicate with the user of said wireless handset via e-mail, SMS, automated voice blast and/or standard mail.

8. The apparatus of claim 1, where said service and billing platform is integrated with a website accounting system where users of said wireless handset can view their transactions and manage their accounts including paying for their services, adding minutes, updating their handsets, adding funds to their balances and changing their contact and service and billing information.

9. The apparatus of claim 1, wherein said service and billing platform is adapted to launch programs and services that can be directly billed to a user of said wireless handset or institutional groups within a short time period.

10. The apparatus of claim 1, wherein said service and billing platform is adapted to enable trial wireless service plans or sample service plans.

11. The apparatus of claim 1, wherein said service and billing platform is adapted to enable minutes or service date updates to be delivered directly from said service and billing platform to said wireless handset after a customer's account is charged or delivery criteria is met.

12. A method, comprising:
using a program administration interface with service and billing platform associated with a prepaid wireless handset to enable the creation and management of programs, business rules, customer communications, reports and back end processes within said service and billing platform.

13. The method of claim 12, wherein said service and billing platform is a rules based program that encompasses program management, payment processing and customer communications in an integrated and flexible fashion.

14. The method of claim 13, further comprising using said service and billing platform in conjunction with said wireless handset to provide customer minutes and service.

15. The method of claim 12, further comprising providing by said service and billing platform recurring or one-time programs or services that deliver minutes or units or dollar amounts or send service due date updates from said service and billing platform via said administration interface directly to said wireless handset.

16. The method of claim 12, further comprising configuring said program administration interface by selecting price, the amount of minutes, service days, charge frequency and frequency of minutes delivery.

17. The method of claim 12, further comprising configuring said business rules using one or more of the following section from the group consisting of: system actions; serial number; account status; transaction outcomes; programs; timing; payment methods; payment history; or stop criteria.

18. The method of claim 17, further comprising including within said business rules, communication triggers to communicate with the user of said wireless handset via e-mail, SMS, automated voice blast and/or standard mail.

19. The method of claim 12, further comprising integrating said service and billing with a website accounting system where users of said wireless handset can view their transactions and manage their accounts including paying for their services, adding minutes, updating their handsets, adding funds to their balances and changing their contact and service and billing information.

20. The method of claim 12, further comprising adapting said service and billing platform to launch programs and services that can be directly billed to a user of said wireless handset or institutional groups within a short time period.

21. A machine-accessible medium that provides instructions, which when accessed, cause a machine to perform operations comprising:
using a program administration interface with service and billing platform associated with a prepaid wireless handset to enable the creation and management of programs, business rules, customer communications, reports and back end processes within said service and billing platform.

22. The machine-accessible medium of claim 21, wherein said service and billing platform is a rules based program that encompasses program management, payment processing and customer communications in an integrated and flexible fashion.

23. The machine-accessible medium of claim 22, further comprising said instructions causing said machine to perform operations further comprising using said service and billing platform in conjunction with said wireless handset to provide customer minutes and service.

24. The machine-accessible medium of claim 21, further comprising said instructions causing said machine to perform operations further comprising providing, by said service and billing platform, recurring or one-time programs or services that deliver minutes or units or dollar amounts or send service due date updates from said service and billing platform via said administration interface directly to said wireless handset.

25. The machine-accessible medium of claim 26, further comprising said instructions causing said machine to perform operations further comprising configuring said program administration interface by selecting price, the amount of minutes, service days, charge frequency and frequency of minutes delivery.

26. The machine-accessible medium of claim 21, further comprising said instructions causing said machine to perform operations further comprising configuring said business rules using one or more of the following section from the group consisting of: system actions; serial number; account status; transaction outcomes; programs; timing; payment methods; payment history; or stop criteria.

27. The machine-accessible medium of claim 26, further comprising said instructions causing said machine to perform operations further comprising including within said business rules, communication triggers to communicate with the user of said wireless handset via e-mail, SMS, automated voice blast and/or standard mail.

28. The machine-accessible medium of claim 26, further comprising said instructions causing said machine to perform operations further comprising integrating said service and billing with a website accounting system where users of said wireless handset can view their transactions and manage their accounts including paying for their services, adding minutes, updating their handsets, adding funds to their balances and changing their contact and service and billing information.

29. The machine-accessible medium of claim 21, further comprising said instructions causing said machine to perform operations further comprising adapting said service and billing platform to launch programs and services that can be directly billed to a user of said wireless handset or institutional groups within a short time period.

30. A system, comprising:
a prepaid wireless handset; and
a service and billing platform including a program administration interface to associate said bill platform with said wireless handset and adapted to allow for the creation and management of programs, business rules, customer communications, reports and back end processes and shared minutes and trial plan administration.

31. The system of claim 30, wherein said service and billing platform is a rules based program that encompasses program management, payment processing and customer communications in an integrated and flexible fashion.

32. The system of claim 31, wherein said program administration interface is configured by selecting price, the amount of minutes, service days, charge frequency and frequency of minutes delivery.

33. The system of claim 31, wherein said business rules are configured using one or more of the following section from the group consisting of: system actions; serial number; account status; transaction outcomes; programs; timing; payment methods; payment history; or stop criteria.

34. The system of claim 33, wherein within said business rules, communication triggers are included to communicate with the user of said wireless handset via e-mail, SMS, automated voice blast and/or standard mail.

35. The system of claim 30, further comprising a website accounting system integrated with said service and billing platform where users of said wireless handset can view their transactions and manage their accounts including paying for their services, adding minutes, updating their handsets, adding funds to their balances and changing their contact and service and billing information.

36. The system of claim 30, wherein said service and billing platform is adapted to launch programs and services that can be directly billed to a user of said wireless handset or institutional groups within a short time period.
